(19) United States
(12) Patent Application Publication
(10) Pub. No.: US 2023/0243046 A1
(43) Pub. Date: Aug. 3, 2023

(54) FLATTENED WIRE MESH ELECTRODE FOR USE IN AN ELECTROLYZER CELL

(71) Applicant: Verdagy, Inc., Moss Landing, CA (US)

(72) Inventors: Thomas H. McWaid, Santa Cruz, CA (US); James R. Penny, Santa Cruz, CA (US); Shizhao Su, Marina, CA (US)

(21) Appl. No.: 18/162,290

(22) Filed: Jan. 31, 2023

Related U.S. Application Data
(60) Provisional application No. 63/305,477, filed on Feb. 1, 2022.

(51) Int. Cl. C25B 9/19; C25B 1/04; C25B 11/055; C25B 13/04

(52) U.S. Cl. CPC C25B 9/19; C25B 1/04; C25B 11/055; C25B 13/04

(57) ABSTRACT

An electrolyzer system has a first half cell with a first electrode and a separator disposed adjacent a side of the first half cell. The separator is configured to separate the first half cell from an adjacent second half cell, and the first electrode is in contact with a face of the separator. The first electrode has a mesh, and portions of the mesh that are in contact with the separator are flattened.

### CLAIM OF PRIORITY

The present application is a non-provisional of and claims the benefit of U.S. Provisional Patent Application No. 63/305,477 (Attorney Docket No. 5973.011PRV) filed on Feb. 1, 2022; the entire contents of which are incorporated herein by reference.

### BACKGROUND

The production of hydrogen can play an important role because hydrogen gas is required for many chemical processes. As of 2019, roughly 70 million tons of hydrogen are produced annually worldwide for various uses, such as oil refining, in the production of ammonia (e.g., through the Haber process), in the production of methanol (e.g., though reduction of carbon monoxide), or as a fuel used in transportation.

Historically, a large majority of hydrogen (˜95%) has been produced from fossil fuels (e.g., by steam reforming of natural gas, partial oxidation of methane, or coal gasification). Other methods of hydrogen production include biomass gasification, low-CO₂ or no-CO₂ emission methane pyrolysis, and electrolysis of water. Electrolysis uses electricity to split water molecules into hydrogen gas and oxygen gas. To date, electrolysis systems and methods have been generally more expensive than fossil-fuel based production methods. However, the fossil-fuel based methods can be more environmentally damaging, generally resulting in increased CO₂ emissions. Therefore, there is a need for cost-competitive and environmentally friendly methods of hydrogen gas producing electrolysis systems and methods.

### SUMMARY

The present disclosure describes systems and methods that can provide for more environmentally friendly and lower-cost production of hydrogen gas via electrolysis of water.

### BRIEF DESCRIPTION OF DRAWINGS

FIG. 1 shows an example of an electrolytic cell.

FIG. 2 shows an example of an electrode assembly.

FIG. 3 shows another view of the electrode assembly in FIG. 2.

FIGS. 4A-4B show an example of a clip used in an electrode assembly.

FIG. 5 shows an example of damage to a separator.

FIG. 6A shows an example of a woven mesh.

FIG. 6B shows and example of a flattened woven mesh.

FIGS. 7A-7C show examples of damage to a separator.

FIGS. 8A-8B show an example of wear on a separator.

FIGS. 9A-9E show examples of weaving patterns that may be used in a woven mesh.

FIG. 10 shows an example of a process for producing an expanded mesh.

FIG. 11 illustrates an example of a calendering process.

### DETAILED DESCRIPTION

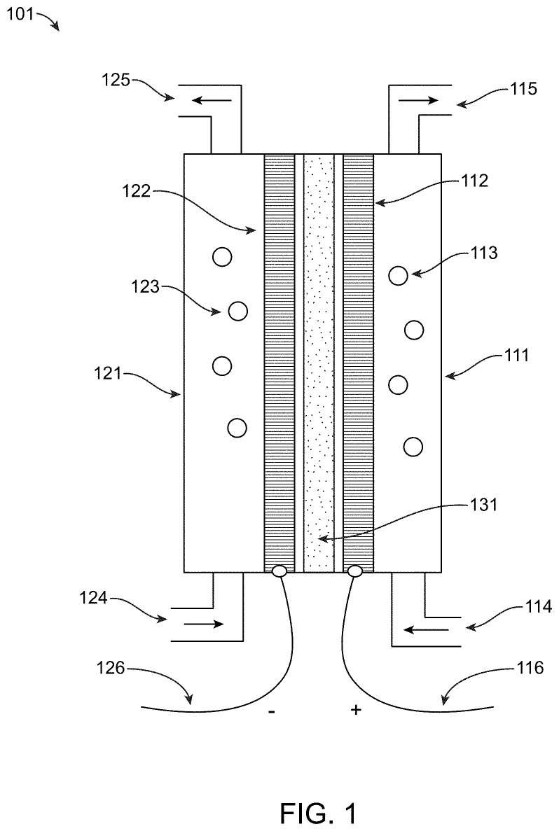

FIG. 1 illustrates a generic water electrolyzer cell 101 that converts water into hydrogen and oxygen with electrical power. The electrolyzer cell 101 comprises two half cells: a first half cell 111 and a second half cell 121, separated by a separator such as a membrane 131. The membrane 131 may be any membrane, including but not limited to, a porous membrane, an ion-solvating membrane, or an ion-exchange membrane. In examples wherein the membrane 131 comprises an ion-exchange membrane, the ion-exchange membrane can be of different types, such as an anion exchange membrane (AEM), a cation exchange membrane (CEM), a proton exchange membrane (PEM), or a bipolar ion exchange membrane (BEM).

In an example, the first half cell 111 comprises a first electrode 112, which can be placed proximate to the separator which in this example is a membrane 131 such as any of those described above, and the second half cell 121 comprises a second electrode 122, which can be placed proximate to the membrane 131, for example on an opposite side of the membrane 131 from the first electrode 112. In an example, the first electrode 112 is the anode for the electrolyzer cell 101 and the second electrode 122 is the cathode for the electrolyzer 101, such that for the remainder of the present disclosure the first half cell 111 will be referred to as the anode half cell 111, the first electrode 112 will be referred to as the anode 112, the second half cell 121 will be referred to as the cathode half cell 121, and the second electrode 122 will be referred to as the cathode 122. In other examples, the first electrode may be the cathode and the second electrode may be the anode.

In an example, the anode 112 is electrically connected to an external positive conductor 116 and the cathode 122 is electrically connected to an external negative conductor 126. When the membrane 131 is wet and is in electrolytic contact with the electrodes 112 and 122, and an appropriate voltage is applied across the conductors 116 and 126 which are electrically coupled with the anode 112 and the cathode 122, respectively, such that oxygen is liberated at the anode 112 and hydrogen is liberated at the cathode 122. In certain configurations, an electrolyte, e.g., one comprising a solution of KOH (potassium hydroxide) in water, is fed into the half cells 111, 121. In an example, the KOH solution of the electrolyte is from about 0.5 molar to about 8 molar. The electrolyte can flow into the anode half cell 111 through a first inlet 114 and into the cathode half cell 121 through a second inlet 124. In an example, the flow of the electrolyte through the anode half cell 111 picks up the produced oxygen as bubbles 113, which exits the anode half cell 111 through a first outlet 115. Similarly, the flow of the electrolyte through the cathode half-cell 121 can pick up the produced hydrogen as bubbles 123, which can exit the cathode half cell 121 through a second outlet 125. The gases can be separated from the electrolyte downstream of the electrolyzer cell 101 with one or more appropriate separators. In an example, the produced hydrogen is dried and harvested into high pressure canisters or fed into further process elements. The oxygen can be allowed to simply vent into the atmosphere or otherwise collected or processed. The electrolyte is recycled back into the half cells 111, 121 as needed.

In an example, the electrochemical cell 101 comprises an anode assembly (e.g., the anode half cell 111) and a cathode assembly (e.g., the cathode half cell 121) separated by the separator 131 such as any of the membranes disclosed above, e.g., an anion exchange membrane (AEM). This assembly forms an electrolytic cell. In an example, the electrodes attached to each half cell 111, 121 (e.g., the anode 112 and the cathode 122) are arranged parallel to one another and to the membrane 131.

Within an assembly of the electrodes 112, 122 and the membrane 131, the electrodes 112, 122 contact one or both faces of the membrane 131 under a controlled load. In an example, elastic elements attached to (or fabricated as part of) the anode 112 and/or the cathode 122 provide for a contact load between the electrode 112, 122 and the membrane 131. This will be illustrated and described in greater detail below.

Fine meshes such as a woven mesh or an expanded mesh have been proven to make excellent electrodes 112, 122. Fine meshes offer high surface area, high open area, and are readily available in the sizes required for a large commercial cell (e.g., from 1 m² to 4 m²). In an example, the woven mesh of one or both of the electrodes 112, 122 comprises a network of sets of crossing wires, which can be perpendicular or angled relative to one another, that alternately cross/bend over one another. In any of the examples disclosed herein, the woven mesh may have any number of weave patterns.

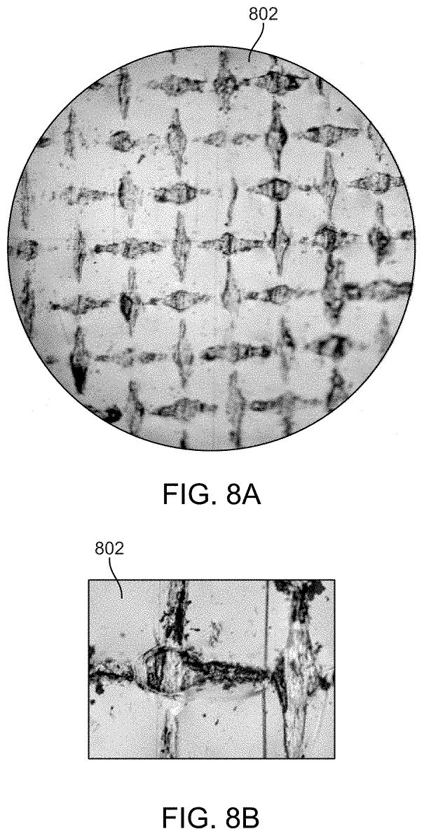

FIGS. 9A-9E illustrate several alternative weave patterns that may be used in a woven mesh electrode.

FIG. 9A shows top and side views of an example of a plain/double weave. Here, the weave results in square openings with wire sizes that may be the same in both directions. Each warp wire passes alternatively over and under the fill wires at right angles, in both directions.

FIG. 9B shows top and side views of an example of a twill square weave. Here, each warp and shute is woven alternatively over two and under two warp wires giving the appearance of two parallel diagonal lines which allows it to be used under greater loads and for finer filtration.

FIG. 9C shows top and side views of an example of a twill Dutch weave. This weave offers higher strength than a plain Dutch weave because it has higher wire density for a given area. Each shute wire may pass over two warp wires and under two resulting in square openings.

FIG. 9D shows top and side views of an example of a reverse plain Dutch weave. Here, a larger count of wires is in the warp and a smaller count of wires in the shute. The warp wires may have a smaller diameter than the shute wires and touch each other. The heavier shute wires are woven as tightly together as possible.

FIG. 9E shows top and side views of an example of a plain Dutch weave. The openings are slanted diagonally. The weave has a coarser mesh and wire in the shute direction.

In any of the woven wire mesh examples, the wires may be crimped together using techniques known in the art such as a lock crimp, double crimp, intercrimp, flat top, or combinations thereof.

For example, in some weave patterns, any particular wire alternates between passing under an adjacent cross wire and then over the next cross wire. When the membrane 131 contacts a woven mesh electrode 112, 122, contact is made across the apexes of the wires as they cross over alternating cross wires. The wire apexes can protrude outward and may be relatively sharp, and therefore the membrane 131 can be subjected to mechanical wear and potentially to mechanical damage at the contact points between the wire apexes and the membrane 131.

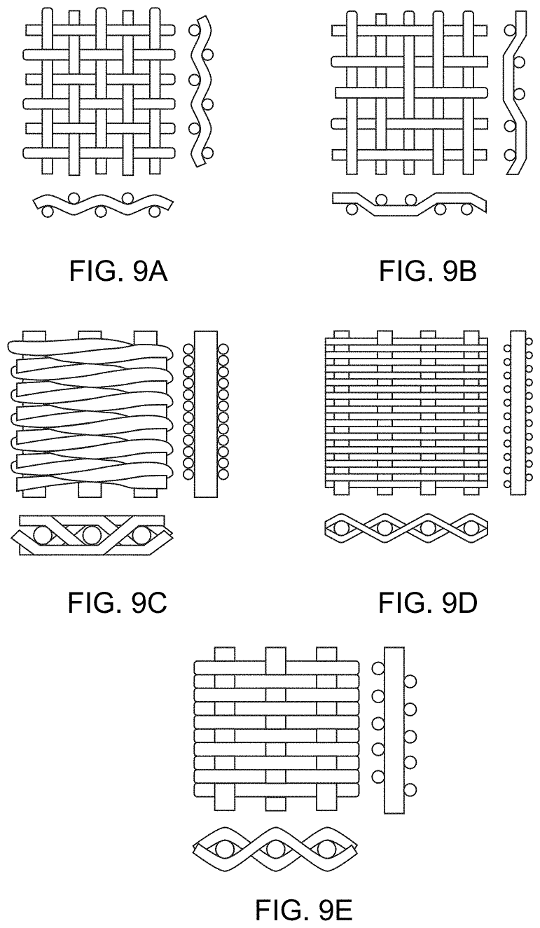

In other examples, the mesh may be an expanded mesh that is used for the electrode. FIG. 10 illustrates formation of an expanded mesh 1002, which is known in the art, and usually involve a flat sheet 1006 of material that is passed under a die or set of perforating scissors 1004 which pierce a hole in the flat sheet which is then expanded to produce the final cell structure 1008 in the expanded mesh. A common cell geometry 1008 are diamond shaped cells in the flat sheet. The manufacturing process that produces the expanded mesh may result in sharp edges or peaks/valleys on the surfaces of the expanded mesh which can protrude outward and damage the membrane.

The present disclosure describes structures and methods that can mitigate the potential mechanical damage caused by the compressive contact between the wire apexes or other protrusions of the mesh electrodes 112, 122 (which may be any mesh disclosed herein including but not limited to the expanded meshes and woven meshes) and the membrane 131.

### Anode Assembly or Cathode Assembly

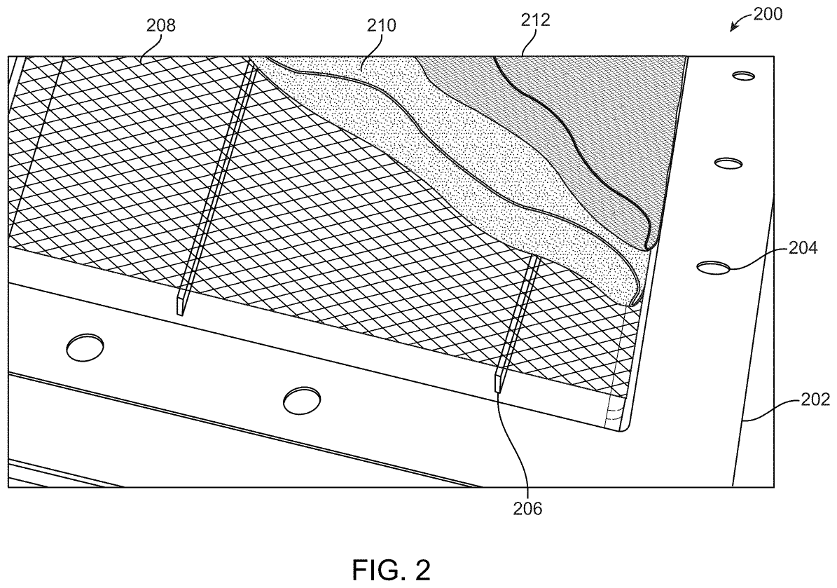

FIGS. 2-4 illustrate an example of an anode assembly or a cathode assembly which optionally may be used in any of the examples of electrolytic cells or half-cells disclosed herein.

FIG. 2 illustrates a partial cut-away view of an example of an electrode assembly 200 that may be an anode assembly or a cathode assembly. Here, an outer frame 202 forms the electrode pan in the electrode assembly. Holes 204 in the outer frame 202 allow bolts or other fasteners to be coupled to the frame to assemble components together. The frame is generally rigid and rectangular or square in shape, but other geometries may be used. The frame provides a substrate for support, attachment, and assembly of components. Ribs 206 extend upward from the bottom of the frame or pan 202 and provide support for the current collector 208 which may be welded or otherwise attached to the ribs 206. The ribs 206 are electrically coupled with the conductors 116 or 126 seen in FIG. 1 above and deliver current from the conductors to the current collector 208. The current collector 208 may be a wire mesh structure that distributes the electrical current over a larger surface area to avoid heat buildup and provides a large contact area to distribute the currently uniformly to the layers of material above it. The wire mesh here, or in any example of a wire mesh may be a woven wire mesh having filaments that are woven together to form the mesh such as those described above, where filaments may undulate above and below the adjacent filaments, or the wire mesh may be an expanded mesh which may be a flat planar mesh which may be formed from a flat sheet of material, as previously described above. Here, the current collector is an expanded mesh and has a series of rows and columns of diamond shaped cells, although any geometry may be used. In some examples, the current collector may be an expanded mesh that is fabricated from a sheet of material about 1.5 mm thick and having a finished thickness of about 1.6 mm thick. The long way of the diamond (LWD) may be about 12.75 mm and the short way of the diamond (SWD) may be about 6.8 mm. The strand width may be about 1.5 mm.

Resting on top of the current collector 208 is an elastic element (sometimes referred to as a mattress) 210. The elastic element is also electrically conductive and conducts current from the current collector 208 to the electrode 212 disposed above. Additionally, the elastic element expands and collapses and provides a controlled load to ensure that the electrode 212 contacts one or both faces of the membrane 131 seen in FIG. 1. Good contact ensures current is delivered to the electrode, avoids arcing or excessive force that can cause mechanical damage to the membrane, electrode, and other adjacent components. The elastic element may be one or more electrically conductive filaments which are woven together into an elastic layer which can expand and collapse and apply the controlled load. In some examples, the elastic element may be a corrugated knitted mesh having a preload about 2 pounds per square inch and/or about 3 mm of compression. The uncompressed thickness of the elastic element may be about 5-7 mm and the corrugation pitch may be about 10 mm. The wire diameter may be about 0.15 mm. In any example, the elastic element may apply a controlled load of about 1-4 psi or a load of about 2 psi against the electrode into the separator. The load may be equal on both sides of the separator, or the loads may be different with the load on one side greater than the load on the opposite side which is lower.

The elastic element may be used in some examples only in the cathode assembly and not the anode assembly, or only in the anode assembly and not the cathode assembly, or in both the anode assembly and the cathode assembly. Therefore, there may be a mattress only on one side of the separator, or there may be a mattress on both sides of the separator.

Electrode 212 (sometimes also referred to as a flynet since it may resemble a screen) which may be an anode, or a cathode electrode is then disposed over the elastic element 210. The electrode may also be a woven mesh or an expanded wire mesh, or any of the electrode examples disclosed herein. In this example, the electrode is a single layer of filaments which are woven over and under adjacent layer of filaments to form the mesh as discussed herein. The electrode 212 is then disposed adjacent the membrane 131 (best seen in FIG. 1). The electrode may contact the membrane, or it may be disposed close to the electrode with a gap therebetween. In an example of a woven wire mesh electrode, the wire diameter may be about 0.18 mm diameter with openings in the mesh about 0.44 mm and an open area of about 50 to 60%. In another example where the electrode is an expanded mesh, the electrode may be fabricated from a sheet of material about 0.13 mm thick with the long way of the diamond shape (LWD) about 2 mm and the short way of the diamond (SWD) about 1 mm, and the open area may be about 50-55%.

In any of the examples of electrodes disclosed herein, the electrode may include a catalyst to help facilitate the electrolytic reaction thereby speeding up the production of hydrogen gas or oxygen gas. Examples of catalysts include, but are not limited to, highly dispersed metals or alloys of platinum group metals, such as platinum, palladium, ruthenium, rhodium, iridium, or their combinations such as platinum-rhodium, platinum-ruthenium, a nickel mesh coated with ruthenium oxide (RuO₂), or a high-surface area nickel. The catalyst may be coated on the electrode, disposed in the electrode or otherwise coupled to or carried by the electrode. The anode alone may include a catalyst, or the cathode electrode alone may include a catalyst, or both the anode and cathode electrodes include a catalyst. The catalyst may be the same for both electrodes or different where the catalyst on the anode is different than the catalyst on the cathode.

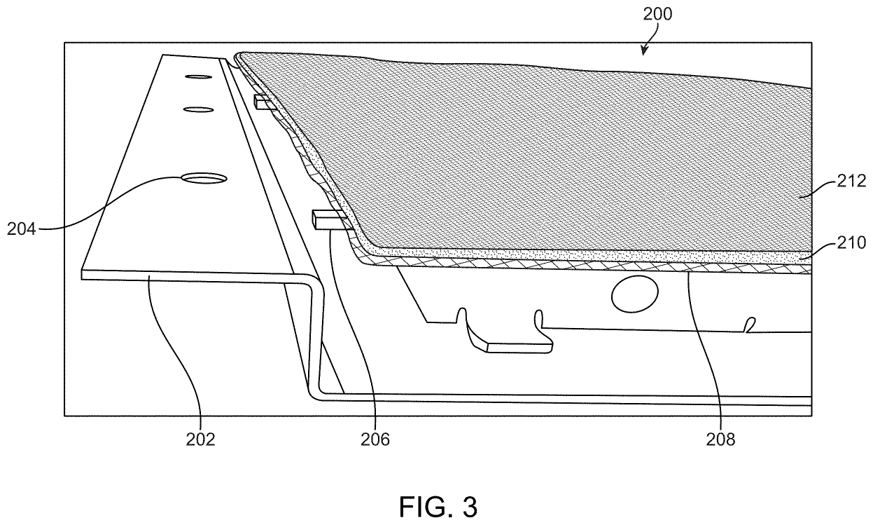

FIG. 3 illustrates a side perspective view of the stacking of various layers in the electrode assembly 200 of FIG. 2. Here, the outer frame 202 (or pan) with holes 204 provide a support for the other components in the cell including the ribs 206, the current collector 208, elastic element 210, and the electrode 212 which may be an anode or cathode depending on whether the assembly is an anode assembly or cathode assembly.

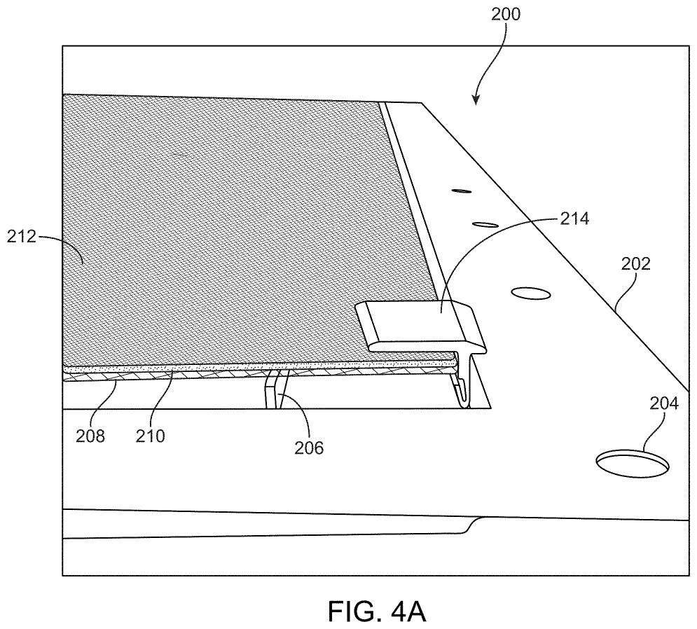

FIG. 4A shows another side perspective view from a different angle of the various layers in the electrode assembly 200 of FIGS. 2-3 but this time with an example of a clip that holds the assembly together. Here, the current collector 208, elastic element 210 and electrode 212 are stacked together as previously described above and coupled to the ribs 206 in the frame 202. In order to help assemble the layers and help keep the layers anchored together, the top layer which is the electrode 212 may extend past the edges of the elastic element 210 and current collector 208 and the electrode may be wrapped around the edges of the elastic element and the current collector, and under the current collector 208. Optionally, one or more clips 214 may be snapped over the edge of the electrode/elastic element/current collector assembly thereby holding all the layers together. The clip may have arms with spring mechanisms that help apply a compressive force to the three-layer assembly to further help hold them together. For example, in the example of FIG. 4A, the clip's hook-like structure can be designed so as to snap into place under the pan-side surface of the current collector, compressing the underlying mattress and flynet, thereby mechanically fastening both the mattress and flynet to the current collector. The clip may have any length and may clip the entire length of the edge of the electrode assembly, or only a portion of the length of the edge. A single clip or multiple clips may be used along the length of the edge.

FIG. 4B shows a side view of FIG. 4A and illustrates how the clip holds the layers in the electrode assembly together as well as preventing loose wires from protruding from the edges thereby protecting adjacent structures from damage, such as the separator.

One or more clips may be used in the anode assembly or the cathode assembly or both the anode assembly and cathode assembly. As described above, in some examples the anode assembly or the cathode assembly may or may not include the elastic element (mattress) and therefore the clip may only be used to hold the electrode (flynet) to the current collector in an anode assembly or a cathode assembly, or both. And in other examples, there may be a current collector, elastic element (mattress) and an electrode (flynet) in the anode assembly or cathode assembly or both, and therefore the clip is used to hold all three layers together. The clip not only holds the layers of the anode or cathode assembly together but also enables rapid servicing of the anode or cathode cells, since a clip may be easily removed and replaced to allow access to the layers. Also, the clip protects the separator from damage caused by loose wires in the electrode, elastic element or current collector that may protrude along their edges.

Other mechanical fasteners may be used in addition to or instead of the clip, as will be appreciated by one of skill in the art. Holding the layers together ensures they do not inadvertently move relative to one another, ensures good electrical contact, and also helps prevent unwanted wear, tear, and damage.

### Flattened Woven Mesh Electrode

As discussed in more detail below, it is desirable to maximize the effective contact area between the mesh of the anode electrode or cathode electrode 112, 122 and the membrane 131. This spreads out the surface area upon which the compression force between the mesh electrode 112, 122 and the membrane 131 is exerted in order to reduce the local stress experienced at any particular point on the membrane 131. In an example, increasing the contact area between the membrane 131 and the wires of the mesh electrode 112, 122 (whether woven mesh or expanded mesh) is accomplished by flattening at least the portions of the wires that protrude furthest from the midplane of the mesh, that is the outer apexes of the crossing over and crossing under wire in a woven mesh, or a protruding portion in an expanded mesh. Flattening these portions of the wires provide for a larger potential contact area between the wires of the electrode 112, 122 and the membrane 131 which reduces contact pressure. The apexes may be on one or both sides of the mesh.

Examples of methods that can be used to increase the potential contact area of the contacting regions of the wire of the woven mesh or expanded mesh electrodes 112, 122, e.g., to flatten portions of the wire, include, but are not limited to mechanical modification of the wire, including by abrasion (e.g., sanding, milling, grinding, etc.) or plastically deforming and flattening the wires at the apexes using compressive loading. As an example, a calendering process can be utilized to plastically deform (flatten) at least a portion of the wire apexes on both sides of a mesh simultaneously. The resultant mesh retains its pliability and, to a great extent, substantially all of its open area percentage. As used herein, the term “substantial” or “substantially” means that a value is within a specified percentage of the stated value (e.g., 100% for the phrase “substantially all”), for example plus-or-minus (“+/−”) within 10% of the stated value, such as +/−within 9.5% of the stated value, for example +/−within 9% of the stated value, such as +/−within 8.5% of the stated value, for example +/−within 8% of the stated value, such as +/−within 7.5% of the stated value, such as +/−within 7% of the stated value, for example +/−within 6.5% of the stated value, such as +/−within 6% of the stated value, for example +/−within 5.5% of the stated value, such as +/−within 5% of the stated value, for example +/−within 4.5% of the stated value, such as +/−within 4% of the stated value, for example +/−within 3.5% of the stated value, such as +/−within 3% of the stated value, such as +/−within 2.5% of the stated value, for example +/−within 2% of the stated value, such as +/−within 1.5% of the stated value, for example +/−within 1% of the stated value, such as +/−within 0.9% of the stated value, for example +/−within 0.8% of the stated value, such as 0.7% of the stated value, for example 0.6% of the stated value, such as 0.5% of the stated value, for example 0.4% of the stated value, such as 0.3% of the stated value, for example 0.2% of the stated value, such as 0.1% of the stated value.

A flattened mesh of the electrode 112, 122 (including woven mesh electrodes and expanded mesh electrodes disclosed herein) will contact the membrane 131 across essentially the same number of contact points as the mesh would have if the mesh had not been flattened. However, the area of each of the contact points will be significantly greater when the wires of the mesh have been flattened at least partially. As a result, the local contact stress at each contact point is spread out across the larger contact area, reducing the mechanical stress at any particular point. This mitigates the amount of mechanical wear at any one point and reduces the potential for local puncturing or other mechanical damage of the membrane 131. The increased contact area also results in a reduction in the local current density across each contact point, which reduces the potential of localized overheating.

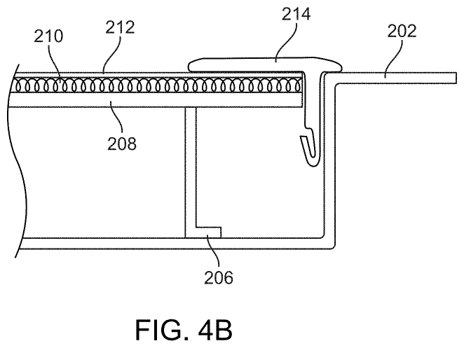

FIG. 5 is a micrograph of a portion of an anion exchange membrane (AEM) 500 after extended operation when contacted with a non-flattened wire woven mesh electrode. The AEM membrane shown in FIG. 5 was operated in a zero-gap configuration, with the non-flattened wire woven meshes loaded in contact with both faces of the AEM membrane. As can be seen in FIG. 5, indentation marks 502 and several holes 504 are apparent where the wire apexes of the woven mesh contacted the AEM membrane.

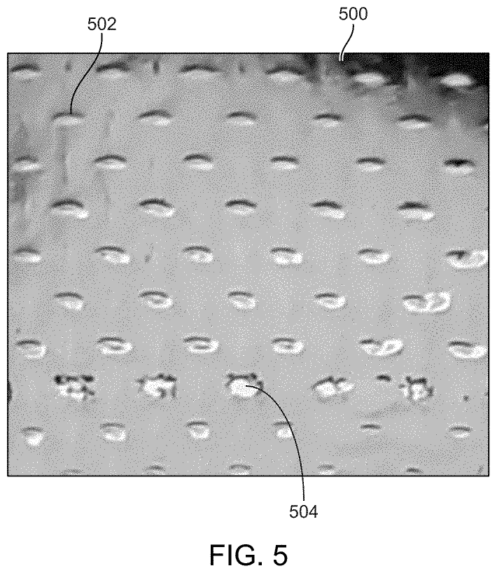

FIGS. 6A and 6B are micrographs, respectively, of a non-flattened woven mesh electrode 602 and a flattened woven mesh electrode 604 according to the present disclosure. The flattened woven mesh shown in FIG. 6B started out being identical to the non-flattened mesh shown in FIG. 6A, but was subsequently flattened using a calendering process. The relatively sharp wire apexes 606 in FIG. 6A at the crossover points of the non-flattened woven mesh are apparent in FIG. 6A. Conversely, as can be seen for the flattened woven mesh in FIG. 6B, the sharp apex points have been significantly blunted after flattening leaving a relatively flat planar apex 608 at the crossover points. The flattened woven mesh in FIG. 6B may be used optionally in one or both of the anode half cell and the cathode half cell.

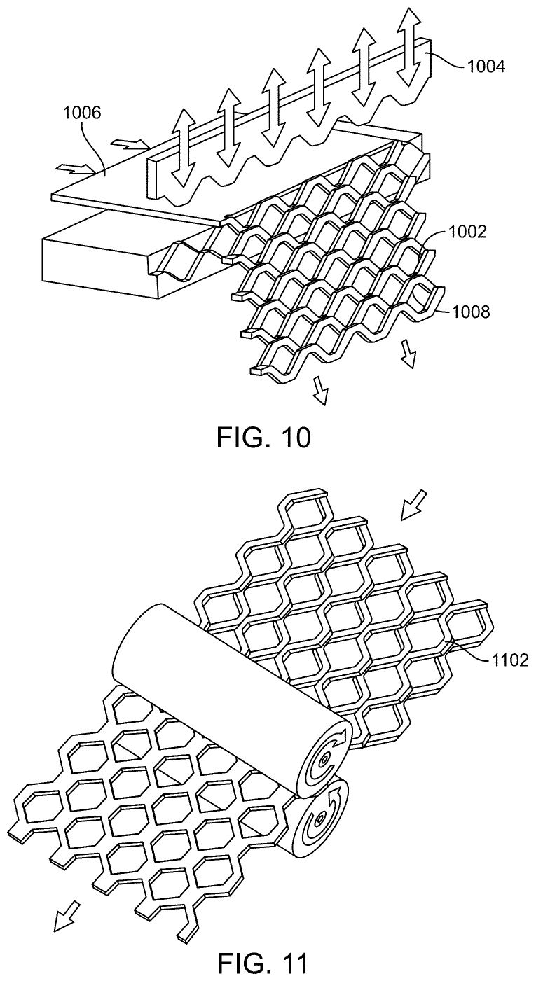

FIG. 11 illustrates an example of a calendaring process where a mesh with sharp or otherwise protruding portions 1102 is passed through rollers to flatten the protrusions and remove the sharp portions. This process may be used to flatten protrusions in woven meshes or expanded meshes disclosed herein, such as in FIG. 6B.

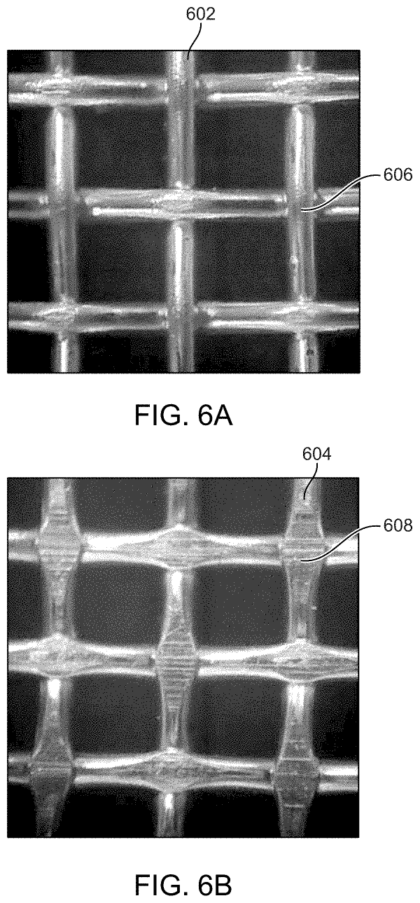

FIGS. 7A-7C are micrographs of a separator such as an AEM membrane 702 after the un-flattened woven mesh electrode 602 of FIG. 6A was driven into hard contact with the AEM 702.

FIG. 7A shows an overall view of the damage that was experienced by the AEM membrane 702 as evidenced by the large number of dark spots which show contact and/or damage.

FIG. 7B shows a closer view of three of the contact points between the un-flattened woven mesh electrode and the AEM membrane 702. Here, the contact points may include wear/abrasion from contact, punctures, and other damage.

FIG. 7C shows a still closer view of a single contact point on the AEM membrane 702 which in this example includes a puncture through the membrane as well as abrasion on the membrane surrounding the puncture.

As can be seen in FIGS. 7A-7C, the damage caused at the areas where there was contact between the crossover apexes of the woven mesh electrode and the AEM membrane is evident. As can be seen, the membrane contained multiple punctures or holes after loading as well as evidence of abrasion on the membrane. It should be noted that the loading force between the woven mesh electrode and the AEM membrane shown in FIGS. 7A-7C was selected to be substantially higher than is typical during operation of an electrolyzer cell in order to more readily show the improvement in mechanical wear mitigation that can be achieved with the flattened woven mesh electrodes of the present disclosure when compared to previous non-flattened mesh electrodes.

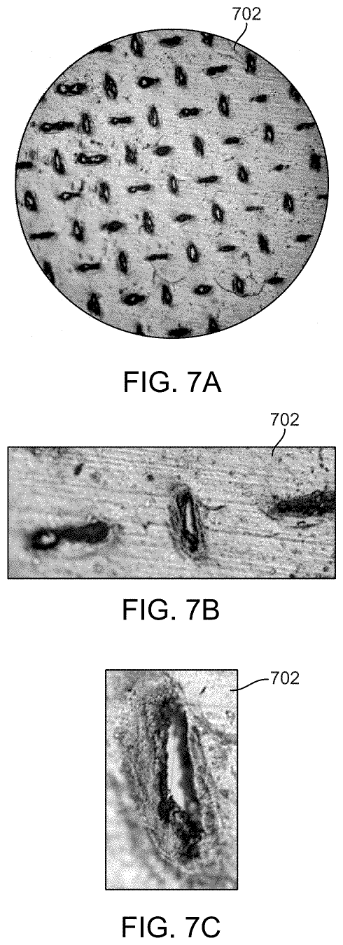

FIGS. 8A and 8B are micrographs of an identical separator such as an AEM membrane 802 to that shown in FIGS. 7A-7C that was subjected to essentially the same mechanical test, but wherein the AEM membrane 802 was contacted with the flattened woven mesh of FIG. 6B.

FIG. 8A is an overall view of the effect on the AEM membrane 802, and FIG. 8B shows a close-up view of two of the contact points where the flattened woven mesh contacted the AEM membrane 802. As can be seen in FIGS. 8A and 8B when compared to FIGS. 7A-7C, the contact areas between the flattened mesh 604 and the AEM membrane 802 was substantially larger than the contact areas between the non-flattened mesh 602 and the AEM membrane 702. As can also be seen in FIGS. 8A and 8B, the larger contact area translated directly to a substantial reduction in the localized stresses at the mesh-membrane contact points. In particular, although the AEM membrane 802 in FIGS. 8A and 8B was also damaged during the aggressive test, no holes were formed in the AEM membrane 802. FIGS. 7A-7C as compared to FIGS. 8A and 8B demonstrate that substituting the flattened woven mesh of the present disclosure for the non-flattened woven mesh previously used in for one or both of the electrodes 112, 122 will improve the lifetime of the membrane 131 during operation of the electrochemical cell 101 when the cell 101 is operated with the membrane 131 in contact with one or both of the electrodes 112, 122.

### NOTES AND EXAMPLES

To better illustrate the electrolyzer systems and methods disclosed herein, a non-limiting list of Examples are provided here:

Example 1 is an electrolyzer system comprising a first half cell with a first electrode; and a separator disposed adjacent a side of the first half cell, the separator configured to separate the first half cell from an adjacent second half cell, wherein the first electrode is in contact with a face of the separator, and wherein the first electrode comprises a mesh, wherein portions of the mesh that are in contact with the separator are flattened.

Example 2 is the electrolyzer of Example 1, further comprising the second half cell, wherein the second half cell comprises a second electrode, the second electrode in contact with the separator, and wherein the second electrode comprises a mesh, wherein portions of the mesh of the second electrode that are in contact with the separator are flattened.

Example 3 is the electrolyzer of any of Examples 1-2, wherein the mesh in the first electrode or the mesh in the second electrode, or both meshes comprise an expanded mesh or a mesh formed from woven wires.

Example 4 is the electrolyzer of any of Examples 1-3, wherein the mesh of one or both of the first electrode and the second electrode are flattened by mechanical modification of the mesh.

Example 5 is the electrolyzer of any of Examples 1-4, wherein the mechanical modification comprises abrasion of the portions of the mesh of the first or second electrodes, or by compressive flattening of the portions of the mesh of the first or the second electrodes.

Example 6 is the electrolyzer of any of Examples 1-5, wherein the mechanical modification comprises calendering of the mesh of the first electrode or the second electrode to compress the portions of the mesh of the first electrode or the second electrode on one or both sides of the respective mesh.

Example 7 is the electrolyzer of any of Examples 1-6, wherein the woven wires of one or both of the first electrode or the second electrode comprise a first set of wires extending in a first direction and a second set of crossing wires extending in a second direction that is angled relative to the first direction, wherein the portions of the mesh that are flattened are located on the first set of wires where each of the first set of wires crosses over one of the second set of crossing wires and on the second set of wires where each of the second set of crossing wires crosses over one of the first set of wires.

Example 8 is the electrolyzer of any of Examples 1-7, wherein the first electrode is a cathode, and the second electrode is an anode.

Example 9 is the electrolyzer of any of Examples 1-8, wherein the separator is an ion exchange membrane.

Example 10 is a method of electrolysis, comprising: providing an electrolytic cell comprising a first half cell and a second half cell, wherein the first half cell comprises a first electrode and an electrolyte, and wherein the second half cell comprises second electrode and an electrolyte, the first half cell coupled to the second half cell, wherein a separator is disposed between the first half cell and the second half cell, and wherein one or both of the first electrode and the second electrode comprises a mesh having peaks, and wherein at least some of the peaks are flattened; passing a current through the electrolysis cell; and producing hydrogen at one of the first electrode and the second electrode, and producing oxygen at the other of the first electrode and the second electrode.

Example 11 is the method of Example 10, wherein the separator is an ion exchange membrane.

Example 12 is the method of any of Examples 10-11, wherein the first electrode is a cathode, and the second electrode is an anode.

Example 13 is the method of any of Examples 10-12, wherein the mesh is a mesh formed from woven wires or an expanded mesh.

Example 14 is a method of manufacturing an electrolyzer, comprising: providing or receiving a first electrode, wherein the first electrode comprises a mesh; providing or receiving a separator; flattening portions of one or more apexes of the mesh that are configured to contact the separator; and assembling the first electrode and the separator into an electrolyzer half-cell assembly such that the flat portions of the mesh of the first electrode are in contact with a corresponding face of the separator.

Example 15 is the method of Example 14, further comprising: providing or receiving a second electrode, wherein the second electrode comprises a mesh; flattening portions of one or more apexes of the mesh of the second electrode that are configured to contact the separator; and assembling the second electrode and the separator into an electrolyzer half-cell assembly such that the flat portions of the mesh of the second electrode are in contact with a corresponding face of the separator; and coupling the half cell with the first electrode together with the half cell with the second electrode.

Example 16 is the method of any of Examples 14-15, wherein assembling the half cell with the first electrode or the half cell with the second electrode comprises compressing one or both of the first electrode and the second electrode into a corresponding face of the separator.

Example 17 is the method of any of Examples 14-16, wherein flattening the portions of the mesh in the first electrode or the second electrode comprises mechanically modifying the mesh.

Example 18 is the method of any of Examples 14-17, wherein mechanically modifying the mesh of the first electrode or the second electrode comprises abrading or compressing the one or more apexes in the first electrode or the second electrode.

Example 19 is the method of any of Examples 14-18, wherein mechanically modifying the mesh of the first electrode or the second electrode comprises calendering the mesh of the first electrode or the second electrode to compress the one or more apexes of the first electrode or the second electrode.

Example 20 is the method of any of Examples 14-19, wherein the one or more apexes of the first electrode or the second electrode are on both sides of the mesh.

Example 21 is the method of any of Examples 14-20, wherein the separator comprises an ion exchange membrane.

Example 22 is the method of any of Examples 14-21, wherein the mesh of one or both of the first and the second electrodes comprises a woven mesh or an expanded mesh.

In Example 23, the apparatuses or methods of any one or any combination of Examples 1-22 can optionally be configured such that all elements or options recited are available to use or select from.

The above detailed description includes references to the accompanying drawings, which form a part of the detailed description. The drawings show, by way of illustration, specific embodiments in which the invention can be practiced. These embodiments are also referred to herein as “examples.” Such examples can include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Although an overview of the inventive subject matter has been described with reference to specific example embodiments, various modifications and changes may be made to these embodiments without departing from the broader scope of embodiments of the present disclosure. Such embodiments of the inventive subject matter may be referred to herein, individually, or collectively, by the term “invention” merely for convenience and without intending to voluntarily limit the scope of this application to any single disclosure or inventive concept if more than one is, in fact, disclosed.

The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

As used herein, the term “or” may be construed in either an inclusive or exclusive sense. Moreover, plural instances may be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and may fall within a scope of various embodiments of the present disclosure. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of embodiments of the present disclosure as represented by the appended claims. The specification and drawings are, accordingly, to be regarded in an illustrative rather than a restrictive sense.

The foregoing description, for the purpose of explanation, has been described with reference to specific example embodiments. However, the illustrative discussions above are not intended to be exhaustive or to limit the possible example embodiments to the precise forms disclosed. Many modifications and variations are possible in view of the above teachings. The example embodiments were chosen and described in order to best explain the principles involved and their practical applications, to thereby enable others skilled in the art to best utilize the various example embodiments with various modifications as are suited to the particular use contemplated.

It will also be understood that, although the terms “first,” “second,” and so forth may be used herein to describe various elements, these elements should not be limited by these terms. These terms are only used to distinguish one element from another. For example, a first contact could be termed a second contact, and, similarly, a second contact could be termed a first contact, without departing from the scope of the present example embodiments. The first contact and the second contact are both contacts, but they are not the same contact.

The terminology used in the description of the example embodiments herein is for the purpose of describing particular example embodiments only and is not intended to be limiting. As used in the description of the example embodiments and the appended examples, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” may be construed to mean “when” or “upon” or “in response to determining” or “in response to detecting,” depending on the context. Similarly, the phrase “if it is determined” or “if [a stated condition or event] is detected” may be construed to mean “upon determining” or “in response to determining” or “upon detecting [the stated condition or event]” or “in response to detecting [the stated condition or event],” depending on the context.

The above description is intended to be illustrative, and not restrictive. For example, the above-described examples (or one or more aspects thereof) may be used in combination with each other. Other embodiments can be used, such as by one of ordinary skill in the art upon reviewing the above description. The Abstract is provided to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description as examples or embodiments, with each claim standing on its own as a separate embodiment, and it is contemplated that such embodiments can be combined with each other in various combinations or permutations. The scope of the invention should be determined with reference to the appended claims, along with the full scope of equivalents to which such claims are entitled.

1. An electrolyzer system comprising:
a first half cell with a first electrode; and
a separator disposed adjacent a side of the first half cell, the separator configured to separate the first half cell from an adjacent second half cell, wherein the first electrode is in contact with a face of the separator, and
wherein the first electrode comprises a mesh, wherein portions of the mesh that are in contact with the separator are flattened.

2. The system of claim 1, further comprising the second half cell, wherein the second half cell comprises a second electrode, the second electrode in contact with the separator, and wherein the second electrode comprises a mesh, wherein portions of the mesh of the second electrode that are in contact with the separator are flattened.

3. The system of claim 2, wherein the mesh in the first electrode or the mesh of the second electrode, or both meshes comprise an expanded mesh or a mesh formed from woven wires.

4. The system of claim 2, wherein the portions of the mesh of one or both of the first electrode and the second electrode are flattened by mechanical modification of the mesh.

5. The system of claim 4, wherein the mechanical modification comprises abrasion of the portions of the mesh of the first or second electrodes, or by compressive flattening of the portions of the mesh of the first or the second electrodes.

6. The system of claim 4, wherein the mechanical modification comprises calendering of the mesh of the first electrode or the second electrode to compress the portions of the mesh of the first electrode or the second electrode on one or both sides of the respective mesh.

7. The system of claim 3, wherein the woven wires of one or both of the first electrode or the second electrode comprise a first set of wires extending in a first direction and a second set of crossing wires extending in a second direction that is angled relative to the first direction, wherein the portions of the mesh that are flattened are located on the first set of wires where each of the first set of wires crosses over one of the second set of crossing wires and on the second set of wires where each of the second set of crossing wires crosses over one of the first set of wires.

8. The system of claim 2, wherein the first electrode is a cathode, and the second electrode is an anode.

9. The system of claim 1, wherein the separator is an ion exchange membrane.

10. A method of electrolysis, comprising:
providing an electrolytic cell comprising a first half cell and a second half cell, wherein the first half cell comprises a first electrode and an electrolyte, and wherein the second half cell comprises second electrode and an electrolyte, the first half cell coupled to the second half cell, wherein a separator is disposed between the first half cell and the second half cell, and
wherein one or both of the first electrode and the second electrode comprises a mesh having peaks, and wherein at least some of the peaks are flattened;
passing a current through the electrolysis cell; and
producing hydrogen at one of the first electrode and the second electrode, and producing oxygen at the other of the first electrode and the second electrode.

11. The method of claim 10, wherein the separator is an ion exchange membrane.

12. The method of claim 10, wherein the first electrode is a cathode, and the second electrode is an anode.

13. The method of claim 10, wherein the mesh is a mesh formed from woven wires or an expanded mesh.

14. A method of manufacturing an electrolyzer, comprising:
providing or receiving a first electrode, wherein the first electrode comprises a mesh;
providing or receiving a separator;
flattening portions of one or more apexes of the mesh that are configured to contact the separator; and
assembling the first electrode and the separator into an electrolyzer half-cell assembly such that the flat portions of the mesh of the first electrode are in contact with a corresponding face of the separator.

15. The method of claim 14, further comprising:
providing or receiving a second electrode, wherein the second electrode comprises a mesh;
flattening portions of one or more apexes of the mesh of the second electrode that are configured to contact the separator; and
assembling the second electrode and the separator into an electrolyzer half-cell assembly such that the flat portions of the mesh of the second electrode are in contact with a corresponding face of the separator; and
coupling the half cell with the first electrode together with the half cell with the second electrode.

16. The method of claim 15, wherein assembling the half cell with the first electrode or the half cell with the second electrode comprises compressing one or both of the first electrode and the second electrode into a corresponding face of the separator.

17. The method of claim 15, wherein flattening the portions of the mesh in the first electrode or the second electrode comprises mechanically modifying the mesh.

18. The method of claim 17, wherein mechanically modifying the mesh of the first electrode or the second electrode comprises abrading or compressing the one or more apexes in the first electrode or the second electrode.

19. The method of claim 17, wherein mechanically modifying the mesh of the first electrode or the second electrode comprises calendering the mesh of the first electrode or the second electrode to compress the one or more apexes of the first electrode or the second electrode.

20. The method of claim 15, wherein the one or more apexes of the first electrode or the second electrode are on both sides of the mesh.

21. The method of claim 14, wherein the separator comprises an ion exchange membrane.

22. The method of claim 15, wherein the mesh of one or both of the first and second electrodes comprises a woven mesh or an expanded mesh.
